(19) United States
(12) Patent Application Publication
(10) Pub. No.: US 2012/0292523 A1
(43) Pub. Date: Nov. 22, 2012

(54) DETECTION OF PLUGGAGE IN APPARATUS OPERATING IN HOT, PARTICLE-LADEN ENVIRONMENTS

(75) Inventors: Kychakoff George, Maple Valley, WA (US); Hogle Richard, Olympia, WA (US)

(73) Assignee: Enertechnix, Inc., Maple Valley, WA (US)

(21) Appl. No.: 13/261,366

(22) PCT Filed: Jan. 20, 2011
(86) PCT No.: PCT/US11/00113

§ 371 Date: Jul. 12, 2012

Related U.S. Application Data
(60) Provisional application No. 61/336,406, filed on Jan. 20, 2010.

(51) Int. Cl. G01J 1/00

(52) U.S. Cl. 250/395; 250/336.1

(57) ABSTRACT

A device for detection of pluggage in an ash hopper of a coal fired boiler to identify when the opening in the bottom of the ash hopper becomes blocked by obstructions, so that timely and effective measures can be taken to remove the blockage without incurring economic loss in the operation of the boiler. At least one microwave or Terahertz transmitter unit configured to produce a microwave beam in either X or K band frequencies or at Terahertz frequencies (300 GHz to 3 THz), and at least one microwave receiver unit or beams that are interrupted by a blockage in the ash hopper, and produce an output to indicate obstruction of the beam or beams by the blockage. When the beam is interrupted, an output signal is produced to indicate obstruction of the beam by the blockage. The output signal is to notify process operators of the need to remove said blockage, and to control a blockage removal process.

This relates to U.S. Provisional Application 61/336,406 filed on Jan. 20, 2010 and entitled Ash Hopper Monitor.

This invention pertains to monitoring of interior structures of apparatus operating in hot, particle-laden environments such as the ash hopper of a coal fired boiler to identify when the opening in the bottom of the ash hopper becomes blocked by obstructions, so that timely and effective measures can be taken to remove the blockage without incurring economic loss in the operation of the boiler.

### BACKGROUND OF THE INVENTION

In the operation of a coal fired boiler, such as used in coal fired electric generation plants, slag chunks periodically fall into the ash hopper. Most slag chunks that fall are small enough to pass directly through the opening in the bottom of the ash hopper, but occasionally larger chunks of slag fall and do not pass through the ash hopper opening, causing pluggage and leading to build-up of slag over the ash hopper opening in the ash hopper trough. Such deposits can lead to a decrease in boiler efficiency and eventually to an outage so that proper cleaning procedures may be carried out. This can be extremely costly for the boiler operator and has long been a cause for concern.

A typical coal fired plant might operate several 750-MW, split-furnace tangential fired boilers, each with low NOx burners. A typical coal mix for such a boiler could be a blend of Powder River Basin or Western United States coal. Some other sources of coal could be used that might cause excessive slag build-up in the boilers, which drives the need for an ash-monitoring device.

No effective acceptable solution has been introduced to solve this problem because the high gas temperatures and ash particle loading near the ash hopper in the interior of the boiler make it not feasible to simply monitor buildup using visible light. The ash hopper portion of the boiler has an average temperature of around 2000° F. with a high concentration of airborne particulate matter. Gaseous absorption and emission of radiation coupled with strong light scattering by the ash particles leads to complete obscuration of images at visible and infrared wavelengths.

### SUMMARY OF THE INVENTION

The object of this invention is to develop a detector system that will alert plant operators when a slag chunk as fallen that is large enough to plug the ash hopper opening.

Since the visible portion of the electromagnetic spectrum is difficult to use to identify when large slag chunks are blocking the ash hopper, we have studied other parts of the electromagnetic spectrum to discover a more effective approach.

We examined a concept using microwave radiation arranged such that microwaves are sent in a beam formation between a transmitter and receiver. If such a beam is broken by a large piece of slag that the microwaves are unable to penetrate, an alarm is triggered.

This scheme relies on interruption of a beam between a transmitter and a receiver. Alignment is fairly critical for the microwave options, and possible complications for the use of microwaves include reflections, which make it difficult to detect interruption or attenuation of the primary beam.

The ash hopper monitoring system includes one or more transmitters (Tx) and receivers (Rx). These devices are physically encased in thermally controlled enclosures that are mounted on the side of the boiler at opposite ends of the hopper trough. Required physical dimensions include two circular holes not bigger than 6″ on opposite ends of the ash hopper trough.

During device operation, the Tx devices continuously send pulses of microwave radiation to the Rx devices. If any obstruction blocks or diffuses these pulses over an extended period of time, an alert is triggered by the system to notify appropriate plant personnel so action may be taken.

A narrow beam microwave transmitter/receiver link helps to prevent false signals and interference patterns. A microwave transmitter/receiver system is used for preliminary on-site testing. Testing personnel observe the behavior of the system with respect to interference from surrounding environmental aspects such as metal, floors/walls, or other materials in the ‘line-of-sight’ of the device.

The transmitter/receiver devices are placed in line with each other (approximately 80 feet apart), arranged such that an obstruction laying in the path of the microwave beam will interrupt the beam. Reflection of the microwaves can be reduced by narrowing the microwave transmission beam. Narrow transmission beams can be achieved by the use of parabolic reflectors or Cassegrain reflectors.

Further reflection reduction may be obtained by angling the beam upwards away from the metal tubes of the hopper.

The Transmitter and Receiver units transmit and receive through openings in the opposite end hopper walls not more than 10″ diameter.

Microwave Transmission power is less than 50 mW.

Transmitter operates in either X or K band frequencies.

Transmitter is modulated at 10 kHz.

Receiver uses amplitude modulation to convert a high frequency signal to low frequency for processing.

The receiver unit outputs a 4-20 mA signal to indicate obstruction of the beam.

The transmitter and receiver units are cooled by vortex coolers using no more than 10 SCFM.

The transmitter and receiver units are powered by 120 VAC at less than 1 amp.

Both transmitter and receiver antennas will be protected from hot gases by an air purging system.

The transmitter and receiver units transmit through an opening in the opposite end hopper walls not more than 10″ diameter.

A microwave transmitter/receiver system is both capable and cost effective at detecting the presence of a pluggage deposit in the lower ash hopper:

### Description of the Drawings

The invention and its many advantages will become clearer upon examination of the following drawings, wherein:

FIG. 1 is a plan view of an unobstructed ash hopper trough, showing the path of a microwave beam;

FIG. 2 is a plan view of the same ash hopper trough, showing a slag obstruction blocking the path of the microwave beam;

FIG. 3 is a schematic side and front elevation of an ash hopper with elements of one embodiment of the invention installed,

FIG. 4 is a schematic front elevation of an ash hopper showing a water cannon in operation removing a slag obstruction

FIG. 5 is an electrical schematic of the microwave transmitter used in the system shown in FIG. 3; and

FIG. 6 is an electrical schematic of the microwave receiver used in the system shown in FIG. 3.

### DESCRIPTION OF THE PREFERRED EMBODIMENT

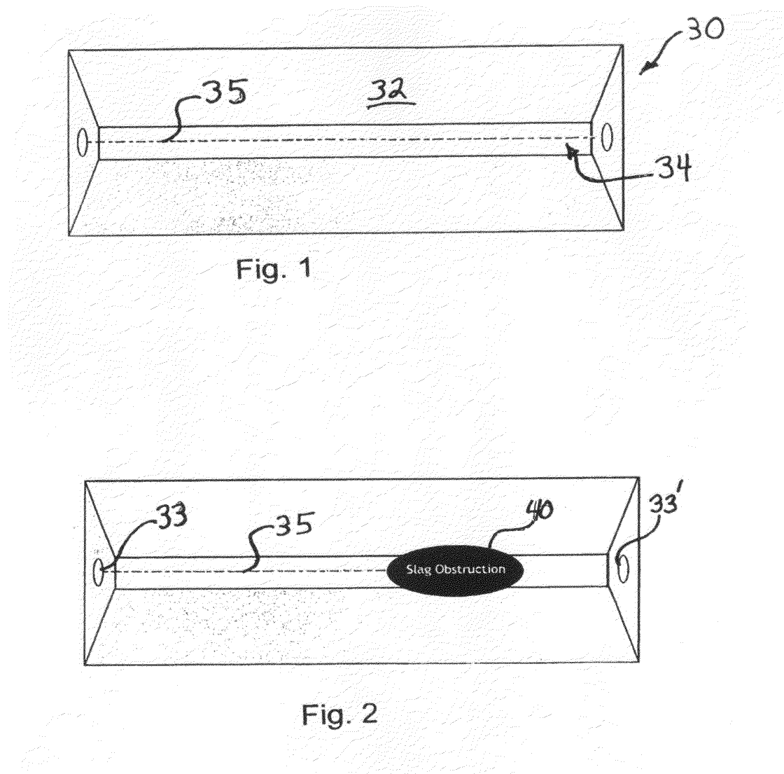

Turning now to the drawings, wherein like reference characters identify like elements, FIG. 1 shows an ash hopper trough 30 having sloping sides 32 and a bottom opening 34 through which ash is discharged. Two circular holes 33 and 33′, not bigger than 10 inches in diameter, are cut in opposite sides 36, 37 of the trough 30 just above the opening 34 to define a line of travel for a microwave beam 35 across the ash hopper. The sides 36, 37 of the ash hopper 30 are typically about 80 feet apart, and the atmosphere in the ash hopper is dense with fumes and dust, making observation with visible light impractical.

When a large chunk of slag, illustrated as slag obstruction 40 in FIG. 2, which is larger than the ash hopper opening 34 falls from the boiler steam tubes into the ash hopper 30, it partially blocks the opening 34 and can cause ash and slag to build up and completely block the opening 34, which can necessitate shutting down the boiler until the blockage can be cleared. If the obstruction can be detected early before it causes a complete blockage of the ash hopper opening, it can often be cleared by obstruction clearing apparatus 38 such as rods or water spays or other processes which break up the obstruction into pieces small enough to pass through the ash hopper opening. One apparatus for producing such a water spray is the “Water Cannon” available from Clyde Bergemann GmbH in Wesel,Germany.

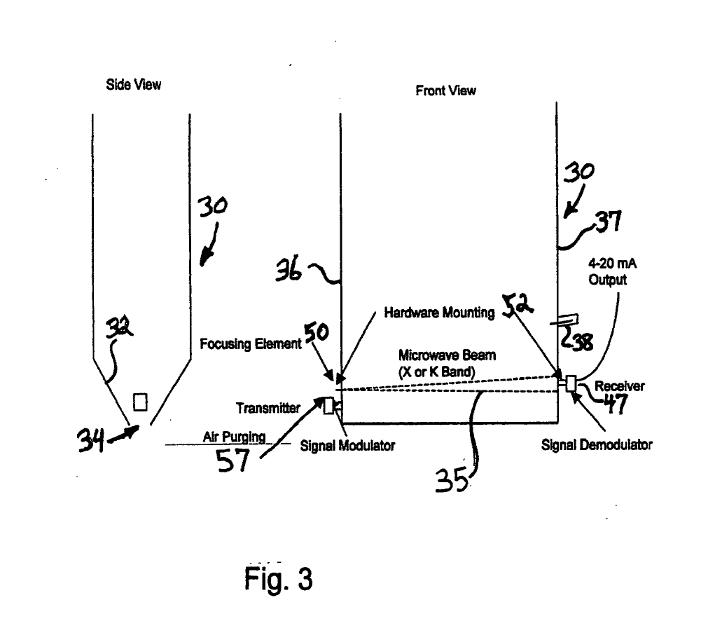

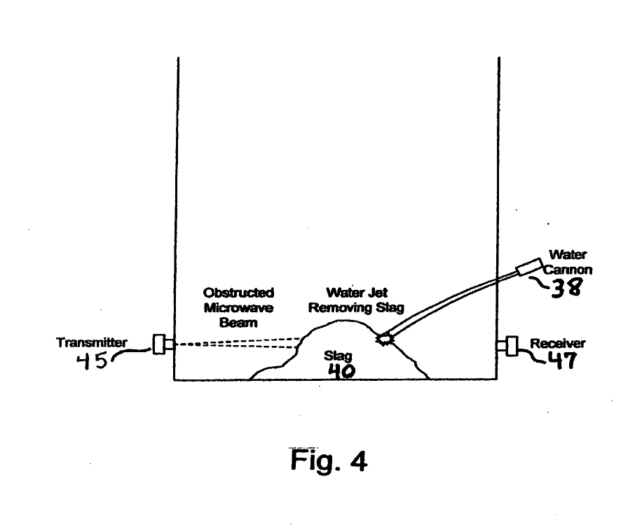

As shown in. FIG. 3, a transmitter 45 and a receiver 47 are mounted on opposite sides of the ash hopper 30. The transmitter 45 generates a microwave signal that is focused in a narrow beam 35 of about 6 degrees by a focusing element 50, mounted over the circular hole 33 and aimed at the circular hole 33′ in the wall 37 on the opposite side of the ash hopper. Based on research and some previous field experience, it was determined that a narrow beam microwave transmitter/receiver link was helpful to prevent false signals and interference patterns. The receiver 47 is mounted on the wall 37 on mounting hardware 52 at the circular hole 33 to receive the microwave beam 35 when the path of the beam 35 is clear, that is, not obstructed by a slag chunk 40. During device operation, the transmitter 45 continuously sends pulses of microwave radiation in the beam 35 to the receiver 47. If any obstruction, such as a slag chunk 40, blocks or diffuses these pulses over an extended period of time, an alert is triggered by a 4-20 mA output signal from the system to notify appropriate plant personnel so that remedial action may be taken without the necessity of shutting down the boiler. The output signal may also automatically trigger operation of the obstruction clearing apparatus 38 which can be mounted on the side of the boiler and aimed at the obstruction to blast it apart, clearing the ash trough opening, as shown in FIG. 4.

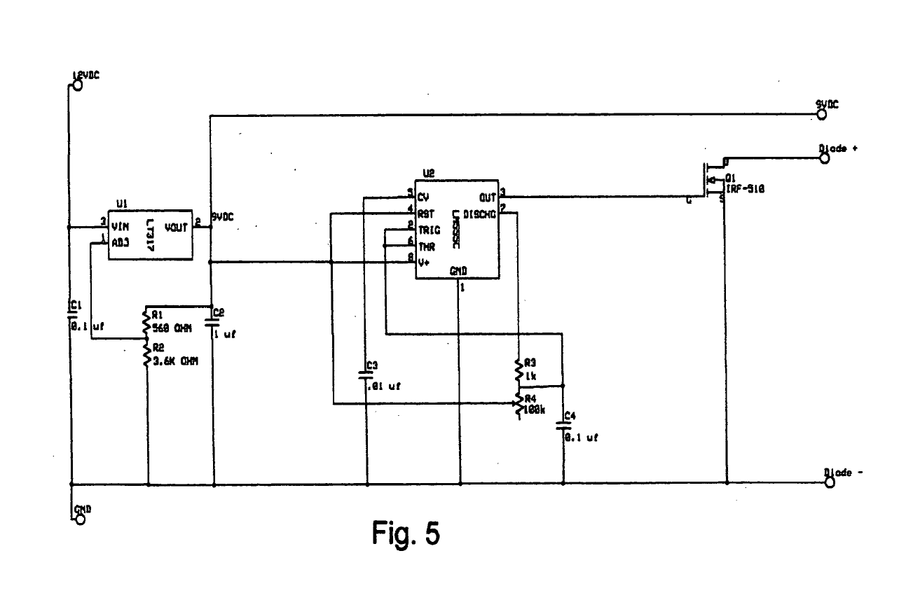

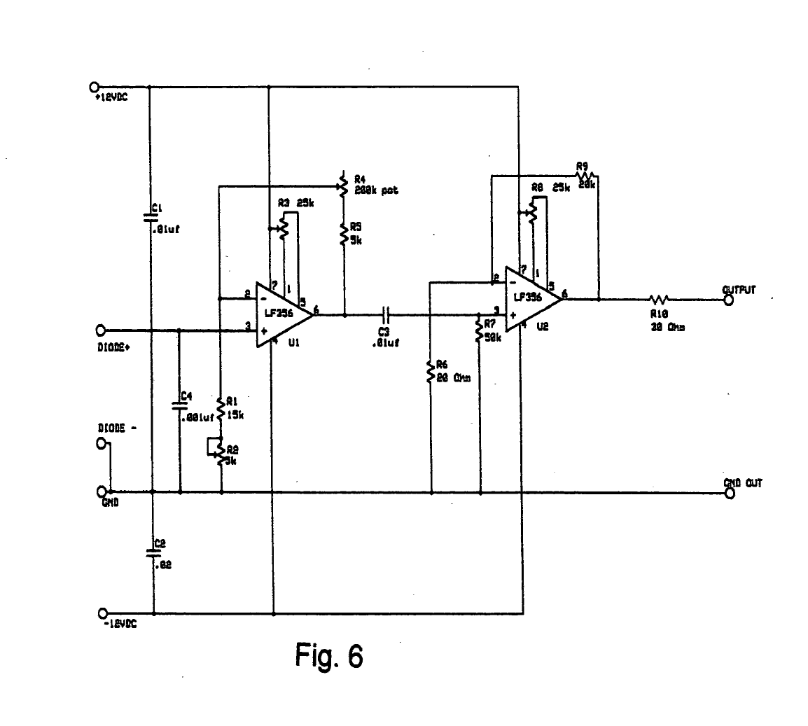

The transmitter and signal modulator are encased in a thermally controlled enclosure that is mounted on the wall 36. An air purging system 57 ensures that the transmitter and signal modulator remains clear of dust from the ash hopper and does not over-heat, and a similar air purging system is also provided for the receiver and the receiver antenna. A vortex cooler 58 may be coupled to either the transmitter 45 or the receiver 47, or both, for cooling these components. An electrical schematic of the microwave transmitter 45 used in the system shown in FIG. 3 is shown in FIG. 5, showing the beam modulating circuit. An electrical schematic of the microwave receiver used in the system is shown in FIG. 6. Suitable vortex coolers are commercially available from several sources, including C. C. Steven, 1363 Donlon Street, Ventura, Calif.

Obviously, numerous modifications and variations of the above-described preferred embodiment are possible and will occur to those skilled in the art in light of this disclosure. For example, the disclosed process and obvious variations of the disclosed structure could be used to detect pluggage in other hard to monitor areas, such as in a cement calciner, and other process applications for detection of pluggage in hot, particle-laden environments. Therefore, what is claimed and desired to be secured by Letters Patent is:

1. A device for detection of pluggage in apparatus operating in hot, particle-laden environments, comprising:
at least one microwave or Terahertz transmitter unit and at least one microwave receiver unit configured to produce a microwave beam or beams that are interrupted by a blockage in said apparatus, configured to produce an output to indicate obstruction of the beam or beams by said blockage.

2. A device as defined in claim 1, wherein:
said microwave transmitter unit is configured to operate in either X or K band frequencies or at Terahertz frequencies (300 GHz to 3 THz).

3. A device as defined in claim 1, wherein:
said signal emitted by said transmitter is modulated, and said receiver unit is configured so to demodulate the transmitted signal thereby improving the signal-to-noise ratio.

4. A device as defined in claim 1, wherein:
said output includes an output signal that is generated to indicate obstruction of said microwave transmitter beam.

5. A device as defined in claim 4, wherein:
said output signal is in the form of a 4-20 mA current.

6. A device, as defined in claim 1, wherein:
said transmitter and receiver units have mounting hardware for mounting by openings in opposite ends of said apparatus.

7. A device as defined in claim 1, wherein:
said transmitter and receiver are sized to transmit and receive through said openings in the opposite end walls of said apparatus not more than 10″ diameter.

8. A device as defined in claim 1, further comprising:
focusing components are coupled to said transmitter for narrowing the microwave transmission beam to reduce reflection of the microwaves transmitted by said transmitter.

9. A device as defined in claim 1, wherein:
said transmitter transmits with a horn antenna with a beam angles <20 degrees.

10. A device as defined in claim 5, further comprising:
an air purging system coupled to both of said transmitter and receiver antennas for protecting said antennas from hot gases.

11. A device as defined in claim 1, further comprising:
vortex coolers using compressed air and coupled to said transmitter and receiver units for cooling said units.

12. A device as defined in claim 1, wherein:
said receiver uses amplitude modulation to convert high frequency signals to low frequency signals for processing.

13. A device as defined in claim 1, wherein:
said apparatus is an ash hopper of a coal fired boiler, and said transmitter is configured to angle said beam upwards away from metal tubes of said hopper to reduce reflection of said beam.

14. A process for detection of pluggage in apparatus operating in hot, particle-laden environments Use of a device for monitoring slag in the trough of an ash hopper of a coal fired boiler, as defined in claim 1, wherein:
producing at least one microwave beam with at least one microwave or Terahertz transmitter unit aimed at at least one microwave receiver unit;
interrupting said microwave beam when a blockage occurs in said apparatus;
producing an output signal to indicate obstruction of said beam by said blockage; and
using said output signal to notify process operators of the need to remove said blockage.

15. A process as defined in claim 14, further comprising:
using said output signal to control a blockage removal process.

16. A process as defined in claim 15, wherein:
said apparatus is an ash hopper of a coal fired boiler, and said blockage removal process is a water cannon or other mechanical means of removing blocking ash from an opening in said ash hopper.
